(19) United States
(12) Patent Application Publication
(10) Pub. No.: US 2011/0098920 A1
(43) Pub. Date: Apr. 28, 2011

(54) Navigation method and system thereof

(75) Inventors: Ping-Da Chuang, Banciao City (TW); Jong-Shyang Liou, Banciao City (TW)

(73) Assignee: INFOEXPLORER CO., LTD, Taipei County (TW)

(21) Appl. No.: 12/805,574

(22) Filed: Aug. 6, 2010

(30) Foreign Application Priority Data
Oct. 26, 2009 (TW) 098136134

(51) Int. Cl. G01C 21/00

(52) U.S. Cl. 701/202

(57) ABSTRACT

A navigation system includes an input module, a spatial database and a routing subsystem. The input module is for user inputting a data of an origin and a destination. The spatial database has a coordinate system and includes a data for point of interest, a way, a path and an area. The path is vertical to ground. The way is parallel to ground. The routing subsystem is connected to the spatial database, and includes a storing unit electrically connected to an operating unit. The storing unit stores the output from the spatial database. The operating unit enumerates all feasible routes between the origin and the destination according to the input data and the coordinate system, and operates the feasible routes to get an optimum route according to the data for the way and the path.

### BACKGROUND OF THE INVENTION

(1) Field of the Invention

The invention relates to a navigation system and method, and especially relates to a navigation system and method serving for a building with multiple floors.

(2) Description of the Prior Art

Currently, the application realm of the pointing navigation is mainly dominated by Global Positioning System (GPS) as the (GPS) can provide accurate position, speed measurement and time standard in high accuracy for most areas on the earth surface. Moreover, the (GPS) can meet requirements for three dimensional location and movement in global point or space as well as time. Therefore, current navigation system offers feature for user to input origin and destination as well as option of transportation preference in accordance with (GPS) and map database to work out a shortcut route by means of routing module.

However, all current route searching engines substantially concentrate on outdoor routing methodology while only few offer indoor moving path but neither having three dimensional spatial layouts nor providing moving ways for moving up and down between floors. Therefore, no current route searching engine can readily perform indoor routing task. Moreover, because current indoor map only provides image file at most but lack of spatial data such as longitudes and latitudes, it can not be used for indoor navigation or indoor routing application.

Accordingly, in a giant exhibition hall, gigantic shopping mall or a prodigious edifice with twin buildings united by a pedestrian overcrossing, a user is hardly to search his/her destination such as lavatory, specific vendor booth or shop by current navigation system available because of neither spotting current relative point nor browsing surrounding environments in three dimension manners. Consequently, how to invent an robust navigation system, which can be used in a building with the functionality of moving up and down between floors, not only providing several feasible route options but also offering an optimal route, becomes an urgent critical issue to be solved by the present invention.

### SUMMARY OF THE INVENTION

The objective of the invention is to provide a navigation system and method for a user to select an optimum route from multiple paths across different floors with setting preference.

Other objectives, features and advantages of the present invention will be further studied from the further technological features disclosed by the embodiments of the present invention.

One embodiment of the present invention is a navigation system, which comprises an input module, a spatial database, a routing subsystem and an output module. The input module serves for users to input a data of an origin and a destination. The spatial database has a coordinate system and an operating unit for processing, storing and operating the spatial data such as longitude and latitude. The operating unit converts the data of the origin, the destination and the spatial data into a coordinate data. In which, the spatial data contains a data for point of interest (POI), a way and a path. The way is parallel to the ground, while the path is vertical to the ground. The routing subsystem is connected to the input module and the spatial database respectively, and includes a storing unit and an operating unit connected to the storing unit. The storing unit is for storing the data output from the spatial database, and the operating unit is connected to the storing unit for enumerating all multiple feasible routes between the origin and the destination. In accordance with the spatial data and the coordinate data, the operating unit works out an optimum route by calculating the feasible routes based on the data for the way and the path. The output module displays the feasible routes and the optimum route.

In an example of the system, the spatial database is a digitized database. Each of the data of the way, the path and the area has a general parameter such as a time control or an access control. The data for point of interest is, for example, a number, a name and a language. The data for the way has a length and a width while the data for the path has a capacity and a time. If the path is an elevator, then the capacity is a loading capacity of the elevator and the time includes the moving time plus a queuing with waiting time of the elevator. If the path is an escalator, then the capacity is a loading capacity of the escalator and the time is the moving time of the escalator. If the path is a stairway, then the capacity includes a tier width of stair, a tier height of stair, a tier number of stair and a length of non-obstacle path. Both the data of the origin and the destination are, for example, coordinates, numbers, names or natural languages.

In another example of the system, the routes is displayed by the output module are in legible and human readable output manner.

One embodiment of the present invention is a navigation method is applied in a user device having an input module and an output module. Users input a data of an origin and a destination in the input module. The method comprises steps of: building up a spatial database having a coordinate system and an operating unit of a spatial data which contains a data for point of interest, a way, a path and an area; storing a data output from the spatial database and the data input by users in a storing unit of a routing subsystem; enumerating multiple feasible routes between the origin and the destination in accordance with the data provided by the spatial database; and an operating unit of the routing subsystem working out an optimum route by calculating the feasible routes based on the data of the way and the path.

In an example of the method, the operating unit of the spatial data converts the data of the origin and the data of the destination into a coordinate data.

In another example of the method, the A* (A-Star) algorithm is engaged during calculation of the optimum route by the operating unit of the routing subsystem.

### BRIEF DESCRIPTION OF THE DRAWINGS

FIG. 1 is a schematic view of a configuration for a navigation system of the present invention.

FIG. 2A is a stereo schematic view of an building with different floors.

FIG. 2B is a perspective view of twin buildings united by an overpass across.

FIG. 3 is a flow chart for an exemplary navigation method of the present invention.

FIG. 4 is a flow chart of A-star (A*) algorithm operated for the routing subsystem in an embodiment of the present invention.

FIG. 5 is a flow chart for an exemplary navigation method of the present invention.

### DESCRIPTION OF THE PREFERRED EMBODIMENTS

Regarding the technical contents, features and effects disclosed above, features and effects of the present invention will be clearly presented and manifested In the following detailed description of the exemplary preferred embodiments with reference to the accompanying drawings which form a part hereof. In this regard, directional terminology such as “top,” “bottom,” “front,” “back,” etc., is used with reference to the orientation of the Figure(s) being described. The components of the present invention can be pointed in a number of different orientations. As such, the directional terminology is used for purposes of illustration and is in no way limiting.

In a giant exhibition hall, gigantic shopping mall or a prodigious edifice with twin buildings united by a pedestrian overcrossing, a user can neither spot current reference point nor browse surrounding environments in three dimension manners. Therefore, the user substantially relies on a powerful navigation system to search his/her destination such as lavatory, specific vendor booth or shop.

The navigation system of the present invention provides proposal scenario list of searched feasible routes with optimum route for user choice by means of minimized total time way in combination of origin and destination input by user, preference, queuing with waiting time as well as crowded and congestion status and the like.

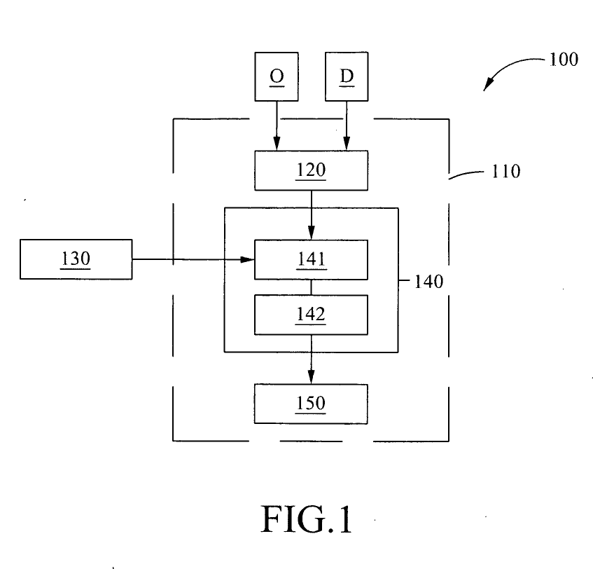

Please refer to FIG. 1, which is a configuration illustrated for a navigation system 100 of the present invention. The navigation system 100, which is applied in a user device 110, comprises an input module 120, a spatial database 130, a routing subsystem 140 and an output module 150. The user device 110, for example, is notebook, personal computer, cellular phone, mobile internet devices (MID) or the like.

The input module 120 serves for user as a mean to input a data of an origin O and a destination D, which can be coordinate, number, name or language. The spatial database 130, which is a digitized database, includes a three dimensional coordinate system, an operating unit of spatial data for processing, storing and operating the spatial data such as longitude and latitude. The operating unit of spatial data converts the data of the origin O and the destination D into a coordinate data so that the routing subsystem 140 can store and operate the coordinate data. In which, the spatial data contains data of point of interest (POI), way and path. The way is parallel to the ground, while the path is vertical to the ground.

The data for point of interest is a number, a name or a language. Data for the way, the path and the area has a general parameter respectively such as a time control or an access control. The data for the way has a length and a width. The data for the path referring to an elevator, an escalator, a stairway or the like, inherently has a capacity and a time. If the path is an elevator, whose capacity is the loading capacity thereof and the time is the moving time plus the queuing with waiting time thereof; if the path is an escalator, whose capacity is a loading capacity thereof and the time parameter is the moving time thereof; and if the path is a stairway, the capacity includes a tier width of stair, a tier height of stair, a tier number of stair and a length of non-obstacle path thereof.

The routing subsystem 140, which is connected to the input module 120, the output module 150 and the spatial database 130 respectively, includes a storing unit 141 and an operating unit 142, wherein the storing unit 141 stores the coordinate data and the spatial data output from the spatial database 130. The operating unit 142, which is connected to the storing unit 141, enumerates all multiple feasible routes between the origin O and the destination D in accordance with data input by user and the coordinate data provided by the spatial database 130, as well as works out an optimum route by calculating all these feasible routes on the basis of the data for the way and the path, wherein the origin O, also known as starting point and abbreviated into origin O while the destination D, also known as terminal point and abbreviated into destination D. The output module 150 displays all foregoing multiple feasible routes and the optimum route in legible and human readable output manner so that the user can easily read and interpret them to judge appropriate selection.

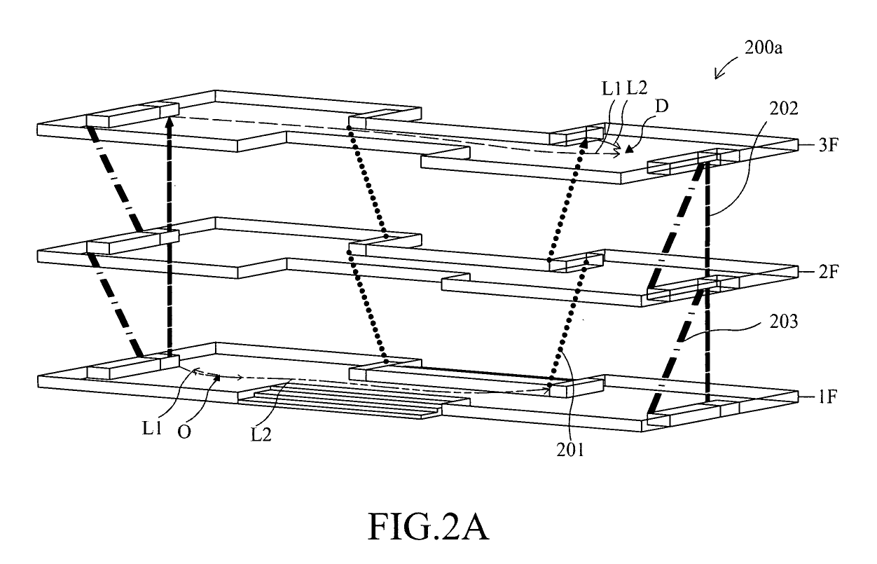

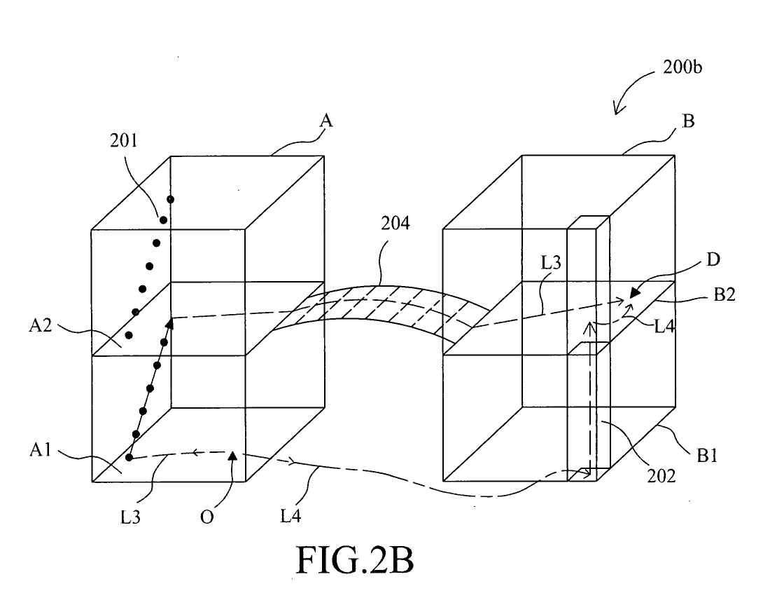

Please refer to FIG. 2A, which is a perspective view of an exemplary exhibition hall 200a with floors to be going up and down by the visitors. The exhibition hall 200a includes floors F1 through F3 such that an escalator 201, an elevator 202 and a stairway 203 are built between each pair of adjacent floors. An user, who is at the origin O, is led to the destination D by means of a navigation system 100 of the present invention.

Firstly, at his/her origin O, the user looks around all surrounding areas and environmental appearances and employs the input module 120 as a means to input data of the origin O and the destination D, which can be a coordinate, a number, a name or a language such as exhibition booth number and name, conference room equipped a projector or the like.

Secondly, the spatial database 130 of the navigation system 100 catches the coordinate data and the spatial data converted from the data of the origin O or the destination D to store in the storing unit 141 of the routing subsystem 140.

Thirdly, the operating unit 142 of the routing subsystem 140 enumerates all multiple feasible routes such as L1 and L2 between the origin O and the t destination D in accordance with coordinate system, data for the way, data for the path and area data for user to select at his/her discretion based on personal preference, wherein feasible route L1 is via elevator 202 to the destination D while feasible route L2 is via escalator 201 to the destination D.

Fourthly, the operating unit 142 of the routing subsystem 140 also works out an optimum route by calculating all foregoing feasible routes on the basis of the data for the way and the path. Suppose the moving time in planar floor movement of feasible route L1 equals the moving time in planar floor movement of feasible route L2, it can be known that a loading capacity, the moving time and a queuing with waiting time for the elevator 202 as well as a loading capacity and a moving time for the escalator 201 from the data for the path. Suppose the loading capacity of elevator 202 is less than the loading capacity of escalator 201. Although the moving time of elevator 202 is less than the moving time of escalator 201, for the queuing with waiting time of elevator 202 is considerable while the queuing with waiting time of escalator 201 is null, total time of moving time and queuing with waiting time of elevator 202 is more than total time moving time and null queuing with waiting time of escalator 201. Therefore, via calculation of the operating unit 142, the feasible route L2 is defined as an optimum route.

Finally, an output module 150 of the navigation system 100 displays all foregoing routes for user reference.

Please refer to FIG. 2B, which is a perspective view of an exemplary gigantic shopping mall 200b with twin buildings A and B united by an overpass 204 across. In the gigantic shopping mall 200b, the building A includes an area A1 (also known as floor A1) and an area A2 (also known as floor A2) while building B includes an area B1 (also known as floor B1) and an area B2 (also known as floor B2). Moreover, an overpass 204 crosses over the area A2 and area B2 between the building A and building B. An escalator 201 and an elevator 202 are built between each pair of adjacent floors.

A user at the area A1 of the building A as an origin O, will be guided to the area B2 of the building B as a destination D by means of a navigation system 100 of the present invention.

Firstly, at his/her origin O, the user looks around all surrounding areas and environmental appearances and employs an input module 120 as a mean to input the data of an origin O such as vendor booth number and name, and the data of a destination D, both can be a language such as vendor booth of shoes or the like.

Secondly, the spatial database 130 of the navigation system 100 catches a coordinate data and spatial data converted from the origin O or the destination D to store in the storing unit 141 of the routing subsystem 140.

Thirdly, the operating unit 142 of the routing subsystem 140 enumerates all multiple feasible routes such as L3 and L4 between the origin O and the destination D in accordance with coordinate system, the way, path and area for user to select at his/her discretion based on personal preference, wherein feasible route L3 is from the area A1 via an escalator 201 to the area A2, then pass overpass 204 to the area B2 of destination D while feasible route L4 is from the area A1 via a pavement to the area B1, then take another elevator 202 to the area B2 of destination D.

Fourthly, the loading capacity and the moving time for the escalator 201 as well as the loading capacity, the moving time and the queuing with waiting time for the elevator 202 can be known from the data for the path. Moreover, a loading capacity and a moving time for the overpass 204 can be calculated from the length and the width thereof known from the data for the way. Suppose the moving time in planar floor movement of feasible route L3 equals the moving time in planar floor movement of feasible route L4 in the gigantic shopping mall 200b. Suppose the loading capacity of elevator 202 equals the loading capacity of escalator 201. Although the moving time of elevator 202 is less than the moving time of escalator 201, for the queuing with waiting time of elevator 202 is considerable while the queuing with waiting time of escalator 201 is null, the total time of moving time and queuing with waiting time of elevator 202 is greater than total time moving time and null queuing with waiting time of escalator 201. However, the feasible route L3 must take account of the loading capacity and moving time of the overpass 204 while feasible route L4 must take account of access control in the area B1, where only the visitor with VIP very important person) card of the gigantic shopping mall 200b are allowed to pass. Therefore, the operating unit 142 of the routing subsystem 140 can also work out the optimum route by calculating all foregoing feasible routes on the basis of the data for the way and the data for the path.

Finally, the output module 150 of the navigation system 100 displays all foregoing routes for user reference.

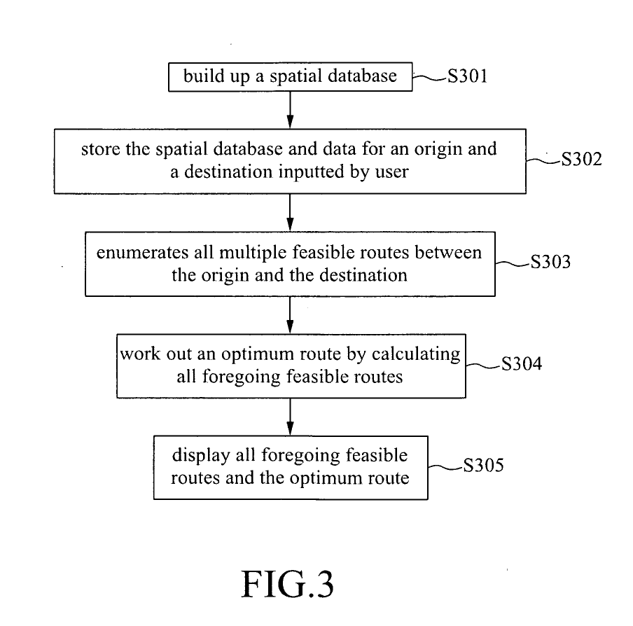

Please refer to FIG. 3, which is a flow chart for an exemplary navigation method of the present invention with steps arranged as following:

Step (S301): Firstly, build up a spatial database. Draw a three dimensional layout into a digitized map such that the spatial database becomes a digitized database, which has a three dimensional coordinate system and includes data for point of interest (POI), the way, the path and the area. Then, apply all the data for the path in respective floor on the basis of the data for the way and the area data in each individual floor, wherein the data for the way is a horizontal distribution, which means the way is parallel to the ground. The data for the path is a vertical distribution, which means the path is vertical to the ground, such as an elevator, an escalator or a stairway.

Step (S302): Store an output data from the spatial database and origin and destination input by user in a storing unit of a routing subsystem.

Step (S303): Enumerates all multiple feasible routes between the origin and the destination in accordance with data provided by the spatial database.

Step (S304): By applying A-star (A*) algorithm, an operating unit of the routing subsystem works out an optimum route by calculating all foregoing feasible routes from the data for the way and the path.

Step (S305): Finally, an output module displays all foregoing feasible routes and optimum route.

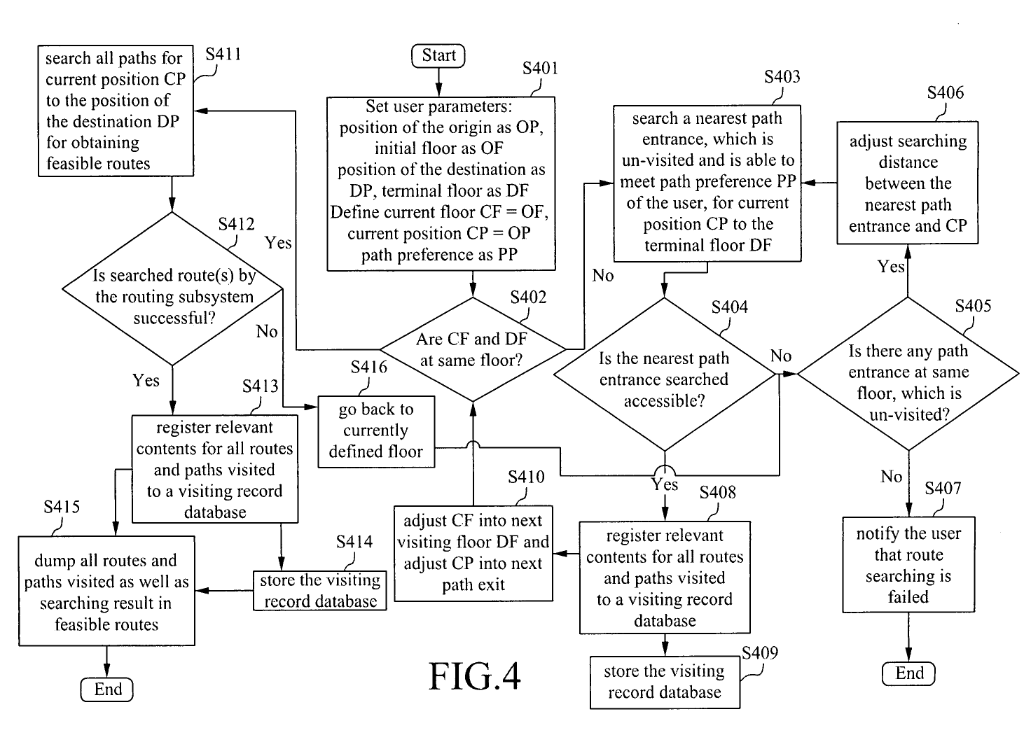

Please refer to FIG. 4, which is a flow chart of A-star (A*) algorithm operated for the routing subsystem in an exemplary preferred embodiment of the present invention with procedure steps arranged as following:

Step (401): Set the data of the origin O and the data of the destination D input by a user as parameters. Label a position of the origin as OP, an initial floor as OF, a position of the destination as DP, a terminal floor as DF, a path preference as PP. Define a current floor CF is the initial floor OF, a current position CP is the position of the origin OP.

Step (402): Judge and decide whether the current floor CF and the terminal floor DF are at same floor. If yes (or true), jump to step (S411); if no (or false), go to run steps (S403) through (S410).

Step (403): If the current floor CF and the terminal floor DF are not at same floor, search a nearest path entrance, which is un-visited and is able to meet the path preference PP of the user, for the current position CP to the terminal floor DF.

Step (404): Judge and decide whether the nearest path entrance searched is accessible. If yes (or true), jump to step (S408); if no (or false), go to step (S405).

Step (405): Judge and decide whether there is any path entrance on the same floor, which is un-visited. If yes (or true), go to step (S406); if no (or false), go to step (S407).

Step (406): If there is any path entrance, which is un-visited and on the same floor, adjust searching distance between the current position CP and the nearest path entrance, and return to step (S403).

Step (407): If no appropriate path is found after having visited all path entrances on the same floor, notify the user that the algorithm is terminated as route searching plan is failed, and prompt the user re-input setting parameters.

Step (408): Access the nearest path entrance, and register relevant contents for all routes and paths visited to a visiting record database.

Step (409): Store the visiting record database in the routing subsystem by the storing unit.

Step (410): Adjust the current floor CF into next visiting floor DF and the current position CP into next path exit, then return to step (S402).

Step (411): If the current floor CF and the terminal floor DF are on the same floor, search all paths for the current position CP to the position of the destination DP for obtaining feasible routes.

Step (412): Judge and decide whether searched route(s) by the routing subsystem 140 is successful. If yes (or true), go to step (S413); if no (or false), go to step (S416).

Step (413): If searched route (s) by the routing subsystem is successful, register relevant contents for all routes and paths visited to a visiting record database.

Step (414): Store the visiting record database in the routing subsystem by the storing unit.

Step (415): All routes worked out from all routes and paths visited are searching result in feasible routes, which can be dumped to display on the output module 150.

Step (416): If searched route(s) by the routing subsystem 140 is failed, then go back to currently defined floor, and return to step (S405).

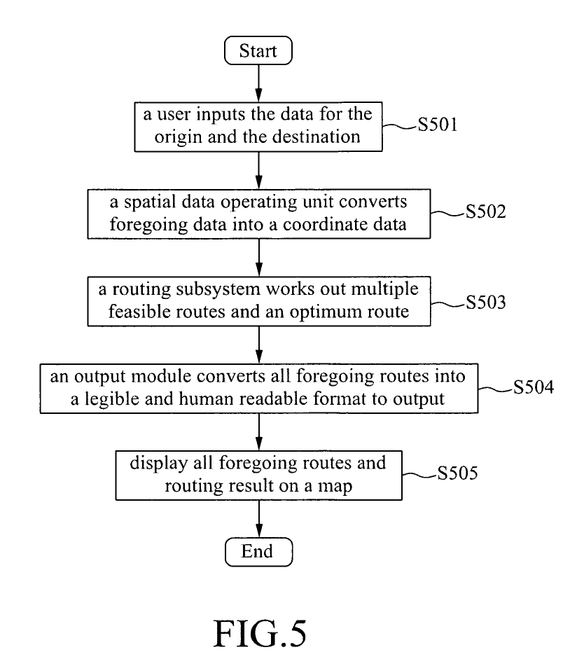

Please further refer to FIG. 5, which is a flow chart for an exemplary navigation method of the present invention with procedure steps arranged as following:

Step (501): A user inputs the data of the origin and the destination.

Step (502): A spatial data operating unit of the spatial database converts the data of the origin and the destination into a coordinate data to store in a routing subsystem for further calculation.

Step (503): A routing subsystem calculates all multiple feasible routes for the user, and works out an optimum route by calculating all foregoing feasible routes on the basis of the data for the way and the path.

Step (504): An output module converts all foregoing routes into a legible and human readable output format such as linguistic text or diagram with mark.

Step (505): Display all foregoing feasible routes and the optimum route on a map in accordance with foregoing data provided by the spatial database so that the user can easily read and interpret them as route searching and distribution.

For a navigation system user, the navigation system and method of the present invention provides an indoor route searching guidance for a giant edifice including multiple sub-building intra-connected by overpasses. The user can input origin and destination settings at any floor or location. Not only certain route searching scheme can be worked out to meet moving preference of the user such as preferred elevator, escalator, stairway, non-obstacle path or minimal total time, but also a comprehensive proposal scenario is enumerated to offer multiple options for user choice at his/her discretion.

However, all foregoing disclosures are only certain exemplary preferred embodiments of the present invention expressed for purposes of illustration and description. It is not intended to confine or limit the range and scope of the present invention. Any equivalent change or modification, which does not depart from the spirit and scope of the present invention, should be reckoned in the coverage of the present invention. Moreover, any objects, advantages and features described heretofore may not apply to all embodiments and claims of the invention. Besides, the abstract of the disclosure and the title of the present invention, which are mainly used to allow a searcher to quickly ascertain the subject matter of the technical disclosure of any patent issued from this disclosure, are not intended to limit or confine the claims.

What is claimed is:

1. A navigation system, comprising:
an input module, serving for users to input a data of an origin and a destination;
a spatial database, having a coordinate system and an operating unit of a spatial data which contains a data for point of interest, a way, a path and an area, wherein the operating unit of the spatial data converts all foregoing data into a coordinate data such that the way is a route parallel to the ground while the path is a route vertical with the ground;
a routing subsystem, connected to the input module and the spatial database respectively, and comprising:
a storing unit for storing the data output from the spatial database; and
an operating unit, electrically connected to the storing unit, enumerating all multiple feasible routes between the origin and the destination in accordance with the spatial data and the coordinate data, as well as working out an optimum route by calculating the feasible routes on the basis of the data for the way and the path, and
an output module for displaying the feasible routes and the optimum route.

2. The navigation system of the claim 1, wherein the spatial database is a digitized database.

3. The navigation system of the claim 2, wherein each of the data of the way, the path and the area has a general parameter, wherein the general parameter is selected from the group consisting of a time control and an access control.

4. The navigation system of the claim 2, wherein the data for point of interest is selected from the group consisting of a number, a name and a language.

5. The navigation system of the claim 2, wherein the data for the way has a length and a width while the data for the path has a capacity and a time.

6. The navigation system of the claim 5, wherein the path is an elevator, and the capacity is a loading capacity of the elevator and the time includes the moving time and a queuing with waiting time of the elevator.

7. The navigation system of the claim 5, wherein the path is an escalator, and the capacity is a loading capacity of the escalator and the time is a moving time of the escalator.

8. The navigation system of the claim 5, wherein the path is a stairway, and the capacity includes a tier width of stair, a tier height of stair, a tier number of stair and a length of non-obstacle path.

9. The navigation system of the claim 1, wherein both the data of the origin and the destination are coordinates, numbers, names or languages.

10. A navigation method, applied in a user device having an input module for users to input a data of an origin and a destination therein, the method comprising steps of:
building up a spatial database having a coordinate system and an operating unit of a spatial data which contains a data for point of interest, a way, a path and an area;
storing a data output from the spatial database and the data input by users in a storing unit of a routing subsystem;
enumerating multiple feasible routes between the origin and the destination in accordance with the data provided by the spatial database; and
an operating unit of the routing subsystem working out an optimum route by calculating the feasible routes on the based on the data of the way and the path.

11. The navigation method of the claim 10, wherein the operating unit of the spatial data converts the data of the origin and the destination into a coordinate data.

12. The navigation method of the claim 10, wherein during calculation of the optimum route by the operating unit of the routing subsystem, an A-star algorithm is further applied.

13. The navigation method of the claim 10, wherein the path is a route vertical to the ground while the data for the way is a route parallel to the ground.

14. The navigation method of the claim 10, wherein the spatial database is a digitized database, and each of the data of the way, the path and the area has a general parameter, wherein the general parameter is selected from the group consisting of a time control and an access control.

15. The navigation method of the claim 14, wherein the data for point of interest is selected from the group consisting of number, name and language.

16. The navigation method of the claim 14, wherein the data of the way has a length and a width while the data of the path has a capacity and a time.

17. The navigation method of the claim 16, wherein the path is an elevator, and the capacity is a loading capacity of the elevator and the time includes the moving time and a queuing with waiting time of the elevator.

18. The navigation method of the claim 16, wherein the path is an escalator, and the capacity is a loading capacity of the escalator and the time is a moving time of the escalator.

19. The navigation method of the claim 16, wherein the path is a stairway, and the capacity parameter includes a tier width of stair, a tier height of stair, a tier number of stair and a length of non-obstacle path.

20. The navigation method of the claim 10, wherein both the data of the origin and the destination are coordinates, numbers, names or natural languages.
